(19) United States
(12) Patent Application Publication
(10) Pub. No.: US 2002/0060287 A1
(43) Pub. Date: May 23, 2002

(54) Structure of a photosensor and method for packaging the same

(76) Inventors: Mon Nan Ho, Hsinchu Hsien (TW); Hsiu Wen Tu, Hsinchu Hsien (TW); Kuo Feng Peng, Hsinchu Hsien (TW); Li Huan Chen, Hsinchu Hsien (TW); Joe Liu, Hsinchu Hsien (TW); Jichen Wu, Hsinchu Hsien (TW); Wen Chuan Chen, Hsinchu Hsien (TW); Yung Sheng Chiu, Hsinchu Hsien (TW)

Correspondence Address: Keith Kline, PRO-TECHTOR INTERNATIONAL SERVICES, 20775 Norada Court, Saratoga, CA, 95070-3018, US

(21) Appl. No.: 09/770,051

(22) Filed: Jan. 24, 2001

Related U.S. Application Data
(63) Continuation-in-part of application No. 09/717,496, filed on Nov. 20, 2000.

(51) Int. Cl. H01J 5/02

(52) U.S. Cl. 250/239

(57) ABSTRACT

A structure of a photosensor for receiving optical signals and converting the optical signals into electrical signals to be transmitted to a circuit board, the structure of the photosensor includes a substrate, a photosensitive chip, and a transparent layer. The substrate has a first surface formed with signal input terminals, and a second surface opposite to the first surface and formed with signal output terminals for electrically connecting the substrate to the circuit board. The photosensitive chip is mounted on the first surface of the substrate and electrically connecting to the substrate. The transparent layer is adhered onto the first surface of the substrate. A cavity is formed at a central portion of the transparent layer. The photosensitive chip on the substrate is located within the cavity of the transparent layer, and the photosensitive chip is capable of receiving the optical signals via the transparent layer. According to this structure of the photosensor, the optical signals can be received more effectively, the quantity of the material can be save, and thus, the manufacturing costs can also be lowered. A method for packaging the photosensor is also disclosed.

### CROSS REFERENCE TO RELATED APPLICATION

This application is a Continuation-In-Part of U.S. patent application Ser. No. 09/717,496, filed Nov. 20, 2000, titled “PHOTOSENSOR PACKAGE STRUCTURE AND METHOD FOR MAKING THE SAME” which is hereby incorporated by reference to the same extent as is fully set forth herein.

### BACKGROUND OF THE INVENTION

1. Field of the invention

The invention relates to a structure of a photosensor and method for packaging the same, in particular, to a structure of a photosensor which can be manufactured easily, save the quantity of the material, and lower the manufacturing costs.

2. Description of the related art

A conventional sensor is usually used for sensing a signal that may be an optical signal or an audio signal. The photosensor of the invention is used for receiving an optical signal or even an image signal. After the optical signal is received, the optical signal is converted into an electrical signal by a photosensor, thereby transferring the signal via a substrate to a printed circuit board.

Referring to FIG. 1, the conventional method for packaging a photosensor includes: providing a substrate 10 formed of a ceramic material, which has an improved radiation effect and a sealing property; mounting a spacer 12 on the periphery of the substrate 10; arranging a photosensitive chip 14 above the substrate 10; and arranging a transparent glass 16 onto the spacer 12 in order to seal the photosensitive chip 14. The photosensor package is thus completed.

In the above-mentioned structure and method of the conventional photosensor, ceramic materials are used to form the substrate 10 in order to achieve a better radiation effect and sealing property. Thus, the costs are high and the photosensor must be manufactured individually, which makes the manufacturing processes not easy and makes the manufacturing costs so high.

The U.S. patent application Ser. No. 09/717,496, filed Nov. 20, 2000, discloses a photosensor package structure and method for making the same in order to solve the above-mentioned problems. Referring to FIG. 2, the photosensor includes a transparent glue 18, a photosensitive chip 19 under the transparent glue 18, and a substrate 20 under the transparent glue 18 and the photosensitive chip 19. According to this structure, the photosensitive chip 19 can be packaged between the transparent glue 18 and the substrate 20. Thus, the manufacturing processes can be facilitated and simplified so that the manufacturing costs can be lowered.

In order to improve the quality of the photosensor as shown in FIG. 2, the invention provides an improved structure of a photosensor in order to improve the transparency and lower the manufacturing costs.

### SUMMARY OF THE INVENTION

It is therefore an object of the invention to provide a structure and method for a photosensor for receiving and transmitting optical signals more effectively.

It is therefore another object of the invention to provide another structure and method for a photosensor capable of saving the materials in order to lower the manufacturing costs.

According to one aspect of the invention, a structure of a photosensor for receiving optical signals and converting the optical signals into electrical signals to be transmitted to a circuit board, the structure of the photosensor includes a substrate, a photosensitive chip, and a transparent layer. The substrate has a first surface formed with signal input terminals, and a second surface opposite to the first surface and formed with signal output terminals for electrically connecting the substrate to the circuit board. The photosensitive chip is mounted on the first surface of the substrate and electrically connecting to the substrate. The transparent layer is adhered onto the first surface of the substrate. A cavity is formed at a central portion of the transparent layer. The photosensitive chip on the substrate is located within the cavity of the transparent layer, and the photosensitive chip is capable of receiving the optical signals via the transparent layer.

According to this structure of the photosensor, the optical signals can be received more effectively via a thinner transparent layer. Thus, the quality of the package structure can be further improved.

### BRIEF DESCRIPTION OF THE DRAWINGS

FIG. 1 is a cross-sectional view showing a conventional structure of a photo sensor.

FIG. 2 is a cross-sectional view showing a structure of a photosensor in accordance with the U.S. patent application Ser. No. 09/717,496.

FIG. 3 is a cross-sectional view showing a structure of a photosensor in accordance with one embodiment of the invention.

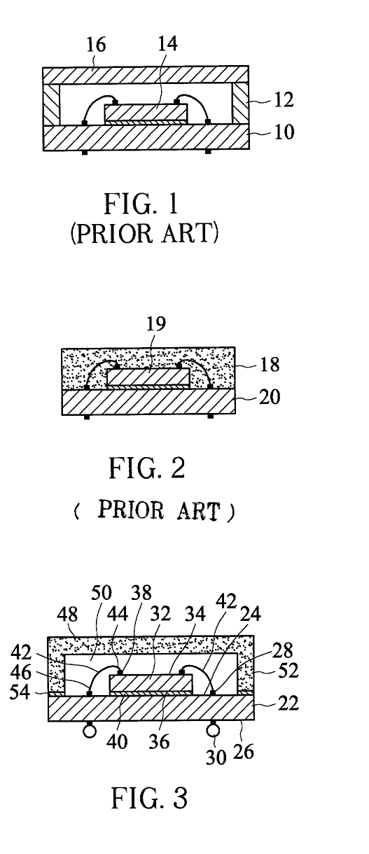

### DETAIL DESCRIPTION OF THE INVENTION

Referring to FIG. 3, the structure of the photosensor of the invention includes a substrate 22, a photosensitive chip 32, and a transparent layer 48.

The substrate 22 has a first surface 24 and a second surface 26 opposite to the first surface 24. The first surface 24 is formed with signal input terminals 28 while the second surface 26 is formed with signal output terminals 30 for electrically connecting to the circuit board (not shown). The signal output terminals 30 may be metallic balls arranged in the form of a ball grid array (BGA).

The photosensitive chip 32 may be an image sensing chip having an upper surface 34 and a lower surface 36. The upper surface 34 is formed with a plurality of bonding pads 38. The lower surface 36 is adhered onto the first surface 24 of the substrate 22 by an adhesive layer 40.

Each of the plurality of wirings 42 includes a first end 44 and a second end 46 opposite to the first end 44. The first ends 44 electrically connect to the bonding pads 38 of the photosensitive chip 32, respectively. The second ends 46 electrically connect to the signal input terminals 28 of the substrate 22, respectively, for electrically connecting the photosensitive chip 32 to the substrate 22 and transmitting the electrical signals to the substrate 22.

The transparent layer 48 is in the shape of “ [symbol] ” so that a central portion formed into a cavity 50. The periphery of the transparent layer 48 is formed with supporting columns 52, which can be adhered onto the first surface 24 of the substrate 22 by an adhesive glue 54 or a tape (not shown). The photosensitive chip 32 is arranged on the substrate 22 and within the cavity 50 of the transparent layer 48 so that the photosensitive chip 32 can receive optical signals via the transparent layer 48. The transparent layer 48 may be a transparent glue formed by injection molding or press molding.

Since the central portion of the transparent layer 48 central portion is formed into a cavity 50, the photosensitive chip 32 can receive optical signals via a thinner transparent layer 48 and obtain a better signal transmission effect. Thus, a better quality of the package structure can also be obtained.

In addition, the [symbol] -shaped structure of the transparent layer 48 can save the quantity of the material, thereby lowering the manufacturing costs.

The method for packaging the photosensor of the invention includes:

providing a substrate 22 having a first surface 24 formed with signal input terminals 28, and a second surface 26 formed with signal output terminals 30;

providing a photosensitive chip 32 mounted onto the first surface 24 of the substrate 22 in order to electrically connect the photosensitive chip 32 to the substrate 22 via a plurality of wirings 42; and

providing a transparent layer 48 formed with a cavity 50 at its central portion, the transparent layer 48 being adhered to the first surface 24 of the substrate 22, wherein the photosensitive chip 32 arranged on the substrate 22 is located within the cavity 50 of the transparent layer 48 so that the photosensitive chip 32 can receive optical signals via the transparent layer 48.

Consequently, the spacer 12 and the process for manufacturing the spacer 12 in the prior art is no longer needed, thereby facilitating the package processes as comparing to the ceramic substrate 10 in the prior art.

While the invention has been described by way of example and in terms of a preferred embodiment, it is to be understood that the invention is not limited to the disclosed embodiment. To the contrary, it is intended to cover various modifications. Therefore, the scope of the appended claims should be accorded the broadest interpretation so as to encompass all such modifications.

What is claimed is:

1. A structure of a photosensor for receiving optical signals and converting the optical signals into electrical signals to be transmitted to a circuit board, the structure of the photosensor comprising:
a substrate having a first surface formed with signal input terminals, and a second surface opposite to the first surface and formed with signal output terminals for electrically connecting the substrate to the circuit board;
a photosensitive chip mounted on the first surface of the substrate and electrically connecting to the substrate; and
a transparent layer adhered onto the first surface of the substrate, a cavity being formed at a central portion of the transparent layer, wherein the photosensitive chip on the substrate is located within the cavity of the transparent layer, and the photosensitive chip is capable of receiving the optical signals via the transparent layer.

2. The structure of the photosensor according to claim 1, wherein the signal output terminals formed on the second surface of the substrate are metallic balls arranged in the form of a ball grid array (BGA).

3. The structure of the photosensor according to claim 1, wherein the photosensitive chip is an image sensing chip.

4. The structure of the photosensor according to claim 1, wherein the photosensitive chip is electrically connected to the substrate via a plurality of wirings.

5. The structure of the photosensor according to claim 1, wherein the transparent layer is in the shape of “ [symbol] ” so as to form a cavity at the central portion of the transparent layer.

6. The structure of the photosensor according to claim 1, wherein the transparent layer is a kind of transparent glue.

7. The structure of the photosensor according to claim 5, wherein the [symbol] -shaped transparent layer is a kind of transparent glue.

8. The structure of the photosensor according to claim 1, wherein the transparent layer having the cavity is formed by injection molding or press molding.

9. The structure of the photosensor according to claim 1, wherein the transparent layer is adhered to the substrate by an adhesive glue or an adhesive tape.

10. A method for packaging a photosensor, comprising:
providing a substrate having a first surface formed with signal input terminals, and a second surface opposite to the first surface and formed with signal output terminals;
providing a photosensitive chip mounted onto the first surface of the substrate, the photosensitive chip being electrically connected to the substrate; and
providing a transparent layer formed with a cavity at its central portion, the transparent layer being adhered to the first surface of the substrate, wherein the photosensitive chip arranged on the substrate is located within the cavity of the transparent layer so that the photosensitive chip can receive optical signals via the transparent layer.

11. The method for packaging the photosensor according to claim 10, wherein the signal output terminals formed on the second surface of the substrate are metallic balls arranged in the form of a ball grid array (BGA).

12. The method for packaging the photosensor according to claim 10, wherein the photosensitive chip is an image sensing chip.

13. The method for packaging the photo sensor according to claim 10, wherein the photosensitive chip is electrically connected to the substrate via a plurality of wirings.

14. The method for packaging the photo sensor according to claim 10, wherein the transparent layer is in the shape of “ [symbol] ” so as to form a cavity at the central portion of the transparent layer.

15. The method for packaging the photosensor according to claim 10, wherein the transparent layer is a kind of transparent glue.

16. The method for packaging the photo sensor according to claim 14, wherein the [symbol] -shaped transparent layer is a kind of transparent glue.

17. The method for packaging the photosensor according to claim 10, wherein the transparent layer having the cavity is formed by injection molding or press molding.

18. The method for packaging the photosensor according to claim 10, wherein the transparent layer is adhered to the substrate by an adhesive glue or an adhesive tape.
